(19) United States
(12) Patent Application Publication
(10) Pub. No.: US 2010/0019050 A1
(43) Pub. Date: Jan. 28, 2010

(54) Automatic Climate Control for a Vehicle

(75) Inventors: Taeyoung Han, Bloomfield Hills, MI (US); James P. Johnson, Detroit, MI (US)

Correspondence Address: MacMillan, Sobanski & Todd, LLC;One Maritime Plaza, 720 Water Street, 5th Floor, Toledo, OH, 43604, US

(73) Assignee: GM GLOBAL TECHNOLOGY OPERATIONS, INC., DETROIT, MI (US)

(21) Appl. No.: 12/179,608

(22) Filed: Jul. 25, 2008

(51) Int. Cl. B60H 1/00; F24F 11/00

(52) U.S. Cl. 236/44 C; 236/91 R; 236/49.1

(57) ABSTRACT

A system and method of operating an automatic climate control system for a vehicle is disclosed. The method may include determining a breath level air temperature in a passenger compartment of the vehicle; determining a mean radiant temperature in the passenger compartment; determining an average air velocity in the passenger compartment; determining a clothing level factor, and calculating an equivalent homogeneous temperature based on the breath level air temperature, the mean radiant temperature, the average air velocity and the clothing level factor; comparing the calculated equivalent homogeneous temperature to a desired equivalent homogeneous temperature; and adjusting an output of the automatic climate control system based on the comparison of the calculated equivalent homogeneous temperature to the desired equivalent homogeneous temperature.

### BACKGROUND OF INVENTION

The present invention relates generally to automatic climate control systems for vehicles.

A typical automotive vehicle with an automatic climate control system uses an in-car temperature sensor mounted in the instrument panel in combination with an ambient air temperature sensor and sometimes a solar load sensor as inputs to the automatic climate control system. The automatic climate control system then uses these inputs, along with a user defined desired temperature to determine the appropriate discharge air temperature, blower speed and the heating, ventilation and air conditioning (HVAC) mode. However, due to air stratification, heat storage in the instrument panel, and discharge from nearby HVAC vents, the accuracy of the temperature measurement from the in-car temperature sensor is degraded. In some vehicle tests, the temperature measured by the in-car temperature sensor may be as much as ten degrees Celsius different from the measured air temperature at a breath level (i.e., air temperature adjacent to the driver's face). Because of this drawback, calibration of the automatic climate control system for a new vehicle is relatively difficult and time consuming.

To improve the temperature sensor measurement at breath level, some have employed ultrasonic temperature sensing. While this improves the temperature measurement at breath level, the thermal comfort of vehicle occupants involves more than just a temperature measurement. For example, radiant heat exchange, the distribution of air velocity, and occupant clothing level all also affect the occupant thermal comfort.

### SUMMARY OF INVENTION

An embodiment contemplates a method of operating an automatic climate control system for a vehicle, the method comprising the steps of: determining a breath level air temperature in a passenger compartment of the vehicle; determining a mean radiant temperature in the passenger compartment; calculating an equivalent homogeneous temperature based on the breath level air temperature and the mean radiant temperature; comparing the calculated equivalent homogeneous temperature to a desired equivalent homogeneous temperature; and adjusting an output of the automatic climate control system based on the comparison of the calculated equivalent homogeneous temperature to the desired equivalent homogeneous temperature.

An embodiment contemplates a method of operating an automatic climate control system for a vehicle, the method comprising the steps of: determining a breath level air temperature in a passenger compartment of the vehicle; determining a mean radiant temperature in the passenger compartment; determining an average air velocity in the passenger compartment; determining a clothing level factor; calculating an equivalent homogeneous temperature based on an equation

$${T}_{EHT} = 0.55 {T}_{a} + 0.45 {T}_{r} + \frac{0.24 - 0.75 \sqrt{{V}_{a}}}{1 + {I}_{clo}} ( 36.5 - {T}_{a} ) ,$$

where T_{EHT} is the equivalent homogeneous temperature in degrees Celsius, Tₐ is the breath level air temperature in degrees Celsius, Tᵣ is the mean radiant temperature in degrees Celsius, Vₐ is the average air velocity in meters per second and l_{clo} is the clothing level factor; comparing the calculated equivalent homogeneous temperature to a desired equivalent homogeneous temperature; and adjusting an output of the automatic climate control system based on the comparison of the calculated equivalent homogeneous temperature to the desired equivalent homogeneous temperature.

An advantage of an embodiment is that a vehicle automatic climate control system employs a more complete control input and thermal comfort calculation for an automatic climate control system, resulting in better thermal comfort for a vehicle occupant.

An advantage of an embodiment is that calibration time and costs may be reduced for the vehicle automatic climate control system employing the equivalent homogeneous temperature input as compared to a conventional automatic climate control system.

### BRIEF DESCRIPTION OF DRAWINGS

FIG. 1 is a schematic illustration of a vehicle and passengers according to a first embodiment.

FIG. 2 is a schematic illustration of a vehicle and passengers according to a second embodiment.

FIG. 3 is a schematic illustration of a portion of an automatic climate control system.

### DETAILED DESCRIPTION

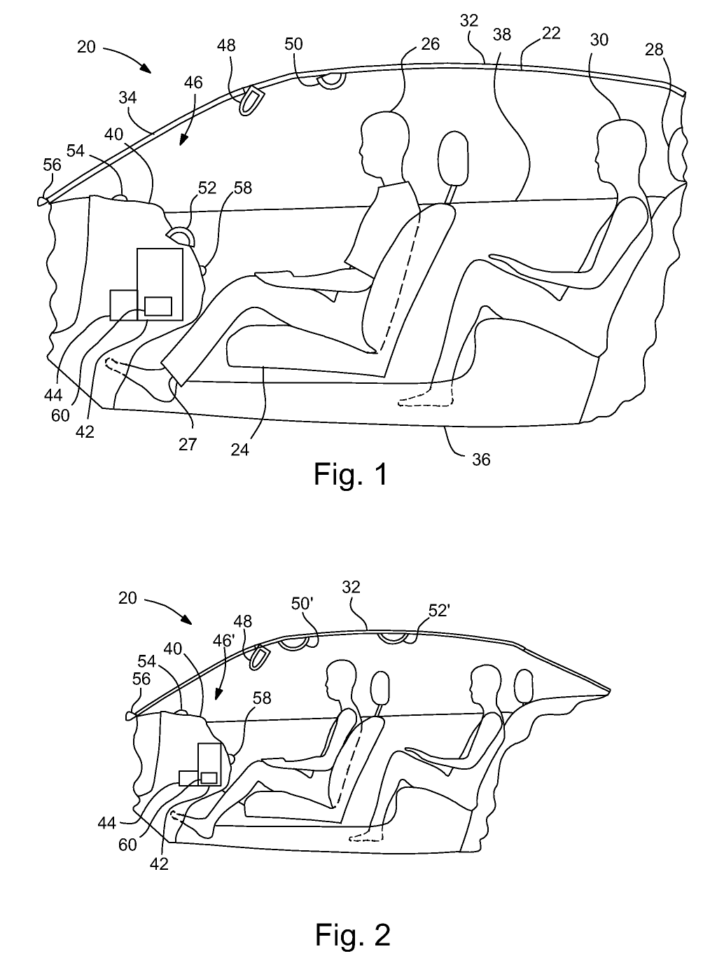

Referring to FIG. 1, a portion of a vehicle, indicated generally at 20, is shown. The vehicle 20 includes a passenger compartment 22 having a driver seat 24 for supporting a driver 26, wearing clothing 27, and a passenger seat 28 for supporting a passenger 30. The passenger compartment 22 is enclosed partially by a roof 32, a windshield 34, a floor 36, and doors 38 with windows. An instrument panel 40 is located in front of the driver seat 24. A HVAC module 42, which is part of an automatic climate control system 46, is located behind, in, or under the instrument panel 40. A HVAC controller 44 communicates with and controls the HVAC module 42 and may be located in or be separate from the HVAC module 42. A blower 60 may be located in the HVAC module 42 to cause air flow through the module 42.

The automatic climate control system 46 also includes an infrared sensor 48 mounted to the roof 32, for taking infrared measurements in front of the vehicle driver 26, and ultrasonic temperature sensors 50, 52, with a first sensor 50 mounted to the roof 32 and a second sensor 52 mounted on the instrument panel 40. The ultrasonic temperature sensors 50, 52 work in conjunction to more accurately determine a temperature reading in front of the vehicle driver 26 than a conventional instrument panel mounted temperature sensor. A solar load sensor 54 may be mounted on the instrument panel 40 to measure an intensity and angle of solar load. An ambient air temperature sensor 56 may be employed to detect the ambient air temperature around the vehicle 20. Also, an optional humidity sensor 58 may be employed. All of the sensors are in communication with the HVAC controller 44.

FIG. 2 illustrates a second embodiment. Since this embodiment is similar to the first, like reference numerals designate corresponding elements in the drawings, and to avoid unnecessary repetition the detailed description thereof will be omitted. Changed elements will be designated with a prime. With this embodiment, the ultrasonic temperature sensors 50′, 52′ are both mounted to the roof 32. The other aspects of the automatic climate control system 46′ may remain unchanged, if so desired.

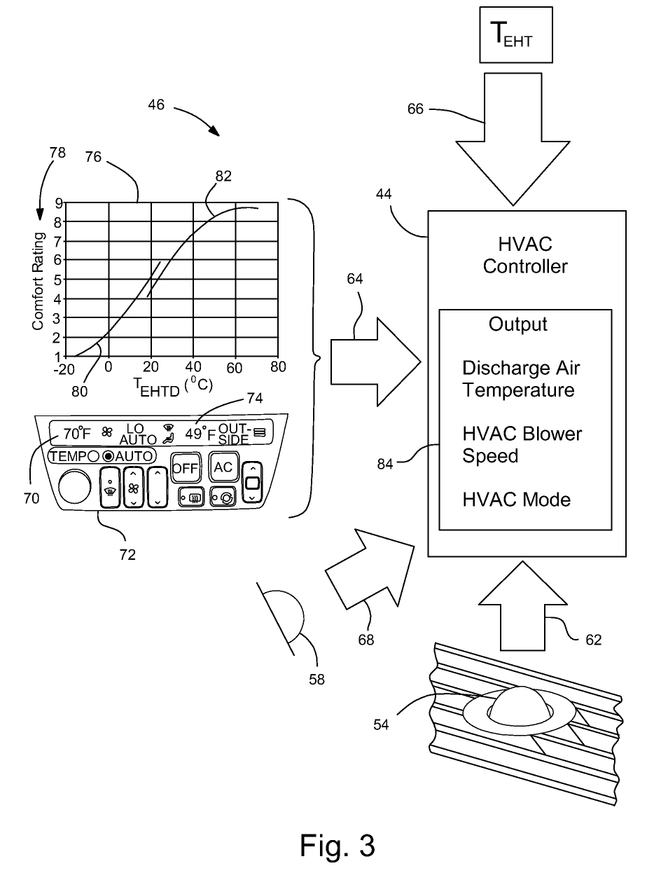

FIG. 3 illustrates a portion of the automatic climate control system 46, 46′ of FIGS. 1 and 2. This portion of the automatic climate control system 46 will be discussed in view of FIG. 1, even though it is applicable to FIG. 2 as well. The HVAC controller 44 includes inputs, indicated by the large arrows, a solar load sensor input 62, a desired thermal comfort input 64, and an equivalent homogeneous temperature (T_{EHT}) input 66. The inputs are shown separate from the HVAC controller 44 for illustrative purposes and may in fact be integrated with the controller, which may take various forms of hardware and software that may be integrated or discrete components as is known to those skilled in the art.

An optional input may be a humidity input 68, received from the optional humidity sensor 58. The relative humidity in the passenger compartment 22 generally has only a minor influence on occupant thermal comfort when its value is below 50%, so it may be employed or not, depending upon the particular vehicle application.

The solar load sensor input 62 to the HVAC controller 44 accounts for the solar load on the driver 26 and passenger 30. The solar load on occupants is dependent on glass properties, solar incidence angle, and incident solar spectrum, which are accounted for by the solar load sensor 54. The solar load sensor 54 communicates with the HVAC controller 44 to create the solar load sensor input 62.

The desired thermal comfort input 64 is based on an occupant requested temperature input 70, which may be a temperature setting made by the driver 26 on an HVAC control panel 72 (which is typically located on the vehicle instrument panel). An outside ambient temperature input 74, as determined by the ambient temperature sensor 56 may also be employed. A look-up table 76 may be employed to determine a desired equivalent homogeneous temperature (T_{EHTD}), which is then communicated as the desired thermal comfort input 64 to the HVAC controller 44.

An equivalent homogeneous temperature is a measure of body heat loss producing a whole body thermal sensation that characterizes the highly non-uniform thermal environment of the vehicle passenger compartment 22. Equivalent homogeneous temperature is a quantity that integrates the effects of breath level air temperature, air velocity and mean radiation to reflect an occupant body heat loss and thus accurately expresses combined thermal effects on an occupant in a single variable that accurately reflects occupant thermal comfort.

The look-up table 76 shows an exemplary graph that employs empirical data to determine a desired T_{EHTD}. A comfort rating 78 is used on the vertical axis and is based on empirical data relating to passenger thermal comfort, with 1 meaning that vehicle occupants feel cold, a 5 meaning occupants are thermally comfortable, up to a 9 where occupants feel hot. A first line 80 on the graph represents vehicle passenger compartment warming during cold ambient conditions, while a second line 82 represents vehicle passenger compartment cooling during hot ambient conditions. The discontinuity at the thermally comfortable level of 5 is due to the fact that people wear more clothing when the ambient temperature is cold and so feel thermally comfortable at a slightly cooler temperature in the passenger compartment 22. The particular comfort rating 78 employed is merely exemplary and other empirical types of comfort ratings may be used in the look-up table instead, if so desired.

The T_{EHT} input 66 is shown separate from the HVAC controller 44 for illustrative purposes, but the calculations to determine T_{EHT} may, in fact, take place inside of the controller 44. The T_{EHT} input 66 is used as feedback in order to allow the HVAC controller 44 to make adjustments to the operation of the automatic climate control system so the desired thermal comfort of the driver 26 and passenger 30 can be attained. The following equations are employed to determine the value of T_{EHT}:

$${T}_{EHT} = 0.5 ( {T}_{a} + {T}_{r} )$$

$$for$$

$${V}_{a} \leq 0.1 m \text{/} s ;$$

$$and$$

$${T}_{EHT} = 0.55 {T}_{a} + 0.45 {T}_{r} + \frac{0.24 - 0.75 \sqrt{{V}_{a}}}{1 + {I}_{clo}} ( 36.5 - {T}_{a} ) , \\ for$$

$${V}_{a} > 0.1 m \text{/} s$$

where Tₐ=a breath level air temperature in degrees Celsius, Tᵣ=a mean radiant temperature in degrees Celsius, l_{clo}=a clothing level factor, and Vₐ=an average air velocity around an occupant in meters per second (m/s). The thermal effect of the clothing level and air velocity magnitude tend to show up when the air velocity magnitude is greater than about 0.1 m/s, which is why the equation for calculating T_{EHT} can be made simpler when air velocities (Vₐ) are less than or equal to about 0.1 m/s.

In order to calculate the T_{EHT} value from these equations, the thermal environmental factors around an occupant—the breath level air temperature (Tₐ), mean radiant temperature (Tᵣ), air velocity around an occupant (Vₐ), and occupant clothing level factor (l_{clo})—are determined.

The breath level air temperature (Tₐ) is an approximation of the dry bulb temperature of the air near an occupant's face. Accurate breath level air temperature (Tₐ) may be estimated based on ultrasonic sensing employing output from the ultrasonic sensors 50, 52.

The mean radiant temperature (Tᵣ) is the uniform surface temperature of an imaginary enclosure in which an occupant would exchange the same amount of radiant heat as in the actual non-uniform space. The output from the infrared sensor 48 provides the mean radiant temperature of the interior surfaces in the field of view of the sensor 48. Thus, a wide field of view infrared sensor is preferred in order to cover most of the surfaces in front of an occupant.

The magnitude of the air velocity around an occupant (Vₐ) influences convective heat transfer. The air velocity around an occupant (Vₐ) is correlated with the total automatic climate control system air flow rate, which is based on the speed of the blower 60 and the particular HVAC mode (e.g., defrost, floor or chest vents) being employed. The particular correlation of blower speed and HVAC mode to air velocity around an occupant (Vₐ) is determined empirically, and depends upon the particular vehicle passenger compartment geometry and vent locations.

A typical clothing level factor (l_{clo}) in hot ambient conditions is about 0.5 and the clothing level factor (l_{clo}) in cold ambient conditions is about 1.0. These produce relatively accurate results for meeting occupant thermal comfort requirements. More specific clothing level factors (l_{clo}) can be introduced as a calibration parameter to the automatic climate control system 46, if so desired.

Having received various inputs 62, 64, 66, 68, the HVAC controller 44 determines the needed output to achieve the desired thermal comfort of the occupant. The HVAC controller 44 may then output a desired discharge air temperature, a desired HVAC blower speed and a HVAC mode needed to achieve occupant thermal comfort.

While certain embodiments of the present invention have been described in detail, those familiar with the art to which this invention relates will recognize various alternative designs and embodiments for practicing the invention as defined by the following claims.

What is claimed is:

1. A method of operating an automatic climate control system for a vehicle, the method comprising the steps of:
(a) determining a breath level air temperature in a passenger compartment of the vehicle;
(b) determining a mean radiant temperature in the passenger compartment;
(c) calculating an equivalent homogeneous temperature based on the breath level air temperature and the mean radiant temperature;
(d) comparing the calculated equivalent homogeneous temperature to a desired equivalent homogeneous temperature; and
(e) adjusting an output of the automatic climate control system based on the comparison of the calculated equivalent homogeneous temperature to the desired equivalent homogeneous temperature.

2. The method of claim 1 wherein step (c) is further defined by the equivalent homogeneous temperature being calculated based on equation T_{EHT}=0.5(Tₐ+Tᵣ), where T_{EHT} is the equivalent homogeneous temperature in degrees Celsius, Tₐ is the breath level air temperature in degrees Celsius, and Tᵣ is the mean radiant temperature in degrees Celsius.

3. The method of claim 1 further comprising the steps of:
(f) determining an average air velocity in the passenger compartment; and
(g) determining a clothing level factor; and
wherein step (c) is further defined by calculating the equivalent homogeneous temperature based on the breath level air temperature, the mean radiant temperature, the average air velocity and the clothing level factor.

4. The method of claim 3 wherein step (c) is further defined by the equivalent homogeneous temperature being calculated based on equation T_{EHT}=0.5(Tₐ+Tᵣ), where T_{EHT} is the equivalent homogeneous temperature in degrees Celsius, Tₐ is the breath level air temperature in degrees Celsius, and Tᵣ is the mean radiant temperature in degrees Celsius, when the average air velocity is less than or equal to about 0.1 meters per second; and the equivalent homogeneous temperature being calculated based on equation
$${T}_{EHT} = 0.55 {T}_{a} + 0.45 {T}_{r} + \frac{0.24 - 0.75 \sqrt{{V}_{a}}}{1 + {I}_{clo}} ( 36.5 - {T}_{a} ) ,$$
where Vₐ is the average air velocity in meters per second and l_{clo} is the clothing level factor, when the average air velocity is greater than about 0.1 meters per second.

5. The method of claim 4 wherein step (g) is further defined by measuring an ambient air temperature, and setting the clothing level factor equal to 1.0 when the measured ambient air temperature is below a predetermined air temperature, and setting the clothing level factor equal to 0.5 when the measured ambient air temperature is at or above the predetermined air temperature.

6. The method of claim 3 wherein step (f) is further defined by the average air velocity being determined based on a speed of a blower and an operating mode in which the automatic climate control system is operating.

7. The method of claim 1 further comprising the step of:
(f) determining a solar load in the passenger compartment; and
wherein step (e) is further defined by adjusting the output of the automatic climate control system based on the comparison of the calculated equivalent homogeneous temperature to the desired equivalent homogeneous temperature and the solar load.

8. The method of claim 1 further comprising the step of:
(f) determining a humidity level in the passenger compartment; and
wherein step (e) is further defined by adjusting the output of the automatic climate control system based on the comparison of the calculated equivalent homogeneous temperature to the desired equivalent homogeneous temperature and the humidity level.

9. The method of claim 1 wherein step (a) is further defined by the breath level air temperature being determined based on an output from ultrasonic sensors located in the passenger compartment.

10. The method of claim 1 wherein step (b) is further defined by the mean radiant temperature being determined based on an output from an infrared sensor.

11. The method of claim 1 wherein step (d) is further defined by the desired equivalent homogeneous temperature being acquired from a look-up table that correlates the desired equivalent homogeneous temperature to a thermal comfort rating.

12. The method of claim 1 wherein step (e) is further defined by the output being at least one of a discharge air temperature, a speed of a blower and an automatic climate control system mode.

13. A method of operating an automatic climate control system for a vehicle, the method comprising the steps of:
(a) determining a breath level air temperature in a passenger compartment of the vehicle;
(b) determining a mean radiant temperature in the passenger compartment;
(c) determining an average air velocity in the passenger compartment;
(d) determining a clothing level factor;
(e) calculating an equivalent homogeneous temperature based on an equation
$${T}_{EHT} = 0.55 {T}_{a} + 0.45 {T}_{r} + \frac{0.24 - 0.75 \sqrt{{V}_{a}}}{1 + {I}_{clo}} ( 36.5 - {T}_{a} ) ,$$
where T_{EHT} is the equivalent homogeneous temperature in degrees Celsius, Tₐ is the breath level air temperature in degrees Celsius, Tᵣ is the mean radiant temperature in degrees Celsius, Vₐ is the average air velocity in meters per second and l_{clo} is the clothing level factor;
(f) comparing the calculated equivalent homogeneous temperature to a desired equivalent homogeneous temperature; and
(g) adjusting an output of the automatic climate control system based on the comparison of the calculated equivalent homogeneous temperature to the desired equivalent homogeneous temperature.

14. The method of claim 13 wherein step (d) is further defined by measuring an ambient air temperature, and setting the clothing level factor equal to 1.0 when the measured ambient air temperature is below a predetermined air temperature, and setting the clothing level factor equal to 0.5 when the measured ambient air temperature is at or above the predetermined air temperature.

15. The method of claim 13 wherein step (c) is further defined by the average air velocity being determined based on a speed of a blower and an operating mode in which the automatic climate control system is operating.

16. The method of claim 13 further comprising the step of:
(h) determining a solar load in the passenger compartment; and
wherein step (g) is further defined by adjusting the output of the automatic climate control system based on the comparison of the calculated equivalent homogeneous temperature to the desired equivalent homogeneous temperature and the solar load.

17. The method of claim 1 further comprising the step of:
(h) determining a humidity level in the passenger compartment; and
wherein step (g) is further defined by adjusting the output of the automatic climate control system based on the comparison of the calculated equivalent homogeneous temperature to the desired equivalent homogeneous temperature and the humidity level.

18. The method of claim 13 wherein step (a) is further defined by the breath level air temperature being determined based on an output from ultrasonic sensors located in the passenger compartment.

19. The method of claim 13 wherein step (b) is further defined by the mean radiant temperature being determined based on an output from an infrared sensor.

20. The method of claim 13 wherein step (f) is further defined by the desired equivalent homogeneous temperature being acquired from a look-up table that correlates the desired equivalent homogeneous temperature to a thermal comfort rating.
